(19) United States
(12) Patent Application Publication
(10) Pub. No.: US 2014/0067398 A1
(43) Pub. Date: Mar. 6, 2014

(54) METHOD, SYSTEM AND PROCESSOR-READABLE MEDIA FOR AUTOMATICALLY VOCALIZING USER PRE-SELECTED SPORTING EVENT SCORES

(71) Applicant: Tony Verna, Woodland Hills, CA (US)

(72) Inventor: Tony Verna, Woodland Hills, CA (US)

(21) Appl. No.: 13/599,987

(22) Filed: Aug. 30, 2012

(51) Int. Cl. G10L 13/04

(52) U.S. Cl. CPC G10L 13/043
USPC 704/260; 704/258

(57) ABSTRACT

A method and system for vocalizing user-selected sporting event scores. A customized spoken score application module can be configured in association with a device. A real-time score can be preselected by a user from an existing sporting event website for automatically vocalizing the score in a multitude of languages utilizing a speech synthesizer and a translation engine. An existing text-to-speech engine can be integrated with the spoken score application module and controlled by the application module to automatically vocalize the preselected scores listed on the sporting event site. The synthetically-voiced, real-time score can be transmitted to the device at a predetermined time interval. Such an approach automatically and instantly pushes the real time vocal alerts thereby permitting the user to continue multitasking without activating the pre-selected vocal alerts.

### CROSS-REFERENCE TO RELATED APPLICATIONS

This patent application claims the benefit under 35 U.S.C. §119(e) of U.S. Nonprovisional application Ser. No. 13/489,990, entitled “Method, System and Processor-Readable Media for Automatically Vocalizing User Pre-Selected Sporting Event Scores”, which is a continuation of Provisional Application Ser. No. 61/499,623 also entitled “Method, System and Processor-Readable Media for Automatically Vocalizing User Pre-Selected Sporting Event Scores,” which was filed on Jun. 21, 2011 and is incorporated herein by reference in its entirety. This patent application also claims the benefit under 35 U.S.C. §119(e) of U.S. Nonprovisional application Ser. No. 13/044,201, entitled “Sports Alert System, Application and Method of use for Smartphones, Computers and Similar Web-enabled Devices”, filed Mar. 9, 2011 and is incorporated herein by reference. This patent application also claims the benefit under U.S.C. §119(e) of U.S. Nonprovisional application Ser. No. 13/455,355, entitled “System and Methods Providing Sports Event Related Media to Internet-enables Devices Synchronized with a Live Broadcast of the Sports Event”, which was filed Apr. 25, 2012 and is a continuation-in-part of application Ser. No. 12/407,916, filed Mar. 20, 2009, which is a continuation of Provisional Application No. 61/038,127, Filed on Mar. 20, 2008, and Provisional Application No. 61/499,623, filed on Jun. 21, 2011, all incorporated by reference herein for their teaching.

### TECHNICAL FIELD

Embodiments are generally related to score sounding methods and systems. Embodiments are also related to text-to-speech conversion engines. Embodiments are additionally related to speech synthesizers. Embodiments are further related to the vocalization of user pre-selected sports scores originally presented as text-posted on existing sports websites (e.g., ESPN). Embodiments are also related to processor-readable media.

### BACKGROUND OF THE INVENTION

Many sports fans follow the live action of a sporting event such as, for example, football, soccer, basketball, cricket, volleyball, hockey, and baseball to witness the action personally or follow a game of interest on a live television or a radio broadcast. However, in some instances, fans are unable to either attend a sporting event or follow the game on a television and/or radio. Therefore, various utilities have been developed to provide the sports fans with alternative means for tracking the live sporting event.

Majority of sports website provide a live event sport coverage to keep track of the score with respect to a sporting event, game, or other activity. Unfortunately, tracking and managing such online information on a mobile communication device and/or a visible screen can be extremely difficult while performing more than one task at the same time. Additionally, accessing such information is very dangerous while driving a vehicle.

Based on the foregoing, it is believed that a need exists for an improved method and system for vocalizing a user-selected sporting event score. A need also exists for automatically transmitting a vocalized score to a device in a multitude of languages utilizing a speech synthesizer, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for unique methods, systems, and processor-readable media for score sounding that vocally augments user selected text scores as posted and updated on at least one existing sports website, whereby a text to speech engine provides defined semantic schema in order to permit an automated attendant to utter the latest scores as pre-requested by a user.

It is another aspect of the disclosed embodiments to provide for unique methods, systems and processor-readable media for vocalizing a user-selected sporting event score from text-postings on an existing sports website.

It is a further aspect of the disclosed embodiments to provide for methods, systems and processor-readable media for automatically transmitting one or more vocalized scores to a device in a single or a multitude of languages utilizing a speech synthesizer.

It is yet a further aspect of the disclosed embodiments to provide for a mobile handheld device application that can transmit synthetically-voiced, real-time sports scores, as selected by a user, and that can be updated automatically and be voiced directly to the user's data-enabled mobile phones or web-enabled devices (e.g., smartphone) without having to log into content providing websites after initial application and user profile setup.

The aforementioned aspects and other objectives and advantages can now be achieved as described herein. A system and method for vocalizing a user-selected sporting event score is disclosed herein. A customized spoken score application module can be configured in association with a device (e.g., a mobile communication device, a data-processing system, a web-enabled device or a Bluetooth audio-enabled vehicle). A real-time score can be preselected by a user from an existing score website (e.g., ESPN, CBS, NBC, Fox) for automatically vocalizing the score in a multitude of languages utilizing a speech synthesizer and a translation engine. An existing text-to-speech engine (e.g., Cisco, Ivano, etc.) can be integrated with the spoken score application module and controlled by the application module to automatically vocalize the preselected scores listed on the sporting event site. The synthetically voiced, real-time score can be transmitted to the device at predetermined time intervals and as preselected by the user. Such an approach automatically and instantly pushes a vocal alert with respect to the score, thereby permitting the user to continue multitasking without activating the pre-selected vocal alerts.

The text-to-speech engine can provide a defined semantic schema in order to permit grammar and application logic development to proceed simultaneously in accordance with the semantic schema. An automated attendant is ready to speak out the latest scores to enhance the nature of digital interaction. The customized server application can generate a sound file from an imported text file (usually in ASCII format) utilizing the existing text-to-speech engine and the resulting sound file can be played back to the user to listen to the scoring updates on the device. The sound file can be generated with low latency as well as minimum resource load on the device. The customized server application can be configured in association with the device, for example, a data-processing system, a web-enabled device or a Bluetooth audio-enabled vehicle, an electronic device, a mobile communication device, an information kiosk and panel, and other home and industrial appliances.

The synthetically-voiced, real-time score can be vocalized with more accurate pronunciations and text processing for all languages (including English, German, Canadian French, Americas Spanish, and Italian), more powerful dictionary features, more capable run-time behavior configuration, enhanced mark-up language support, and changes to the core algorithms. The request can be governed by protocols and the sporting event being contested can be tapped from the device to vocalize the content for the predefined time interval. The text-to-speech engine and libraries work on all customer platforms and devices at maximum performance, with minimal memory, processing footprint, and highest speech quality. The system provides maximum performance on the device with minimal hardware requirements for the aforementioned text-to-speech engine and its libraries for easy integration with the existing software of all score website platforms.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a system that includes a spoken score application module, an operating system, and a user interface, in accordance with the disclosed embodiments;

FIG. 2 illustrates a block diagram of a spoken score system for vocalizing a user-selected sporting event score, in accordance with the disclosed embodiments;

FIG. 3 illustrates a high level flow chart of operations illustrating logical operational steps of a method for vocalizing the user-selected sporting event score, in accordance with the disclosed embodiments; and

FIG. 4 illustrates another high level flow chart of operations illustrating logical operational steps of a method for vocalizing the user-selected sporting event score, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, SD media, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The embodiments are described in part below with reference to flowchart illustrations and/or block diagrams of methods, systems, and/or computer program products and data structures. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

Although not required, the disclosed embodiments will be described in the general context of computer-executable instructions, such as program modules, being executed by a single computer. In most instances, a “module” constitutes a software application. Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, text-to-speech, etc.

The disclosed approach vocally augments selected sports scores from an existing sports website and then instantly transmits the vocalization of those scores at user-requested time intervals and spoken in user-requested languages for automatic transmission to a user device such as, for example, a phone (e.g., Smartphone) or web-enabled device without any activation by the user. A uniquely configured text-to-speech engine with a defined semantic schema can be applied in order to permit grammar and application logic development to proceed with digital interaction simultaneously in accordance with the semantic schema so as to permit an automated attendant to utter the latest scores as pre-requested by a user from an existing major score site and to automatically vocalize score in a multitude of languages utilizing speech synthesizer and translation engine.

In general, a customized server application can be utilized to generate the sound file from an imported text file (usually in ASCII format) via the a text-to speech engine and the resulting sound file can be played back to the user at pre-requested intervals. The customized server application can be configured in association with the device, for example, a data-processing system, a web-enabled device or a Bluetooth audio-enabled vehicle, an electronic device, a mobile communication device, an information kiosk and panel, and other home and industrial appliances.

Computer program code supplying the instructions for carrying out operations of one or more embodiments may be written in an object oriented programming language (e.g., Java, C++, etc.). The computer program code, however, for carrying out operations of the disclosed embodiments may also be written in conventional procedural programming languages such as, for example, the “C” programming language or in a visually oriented programming environment such as, for example, Visual Basic.

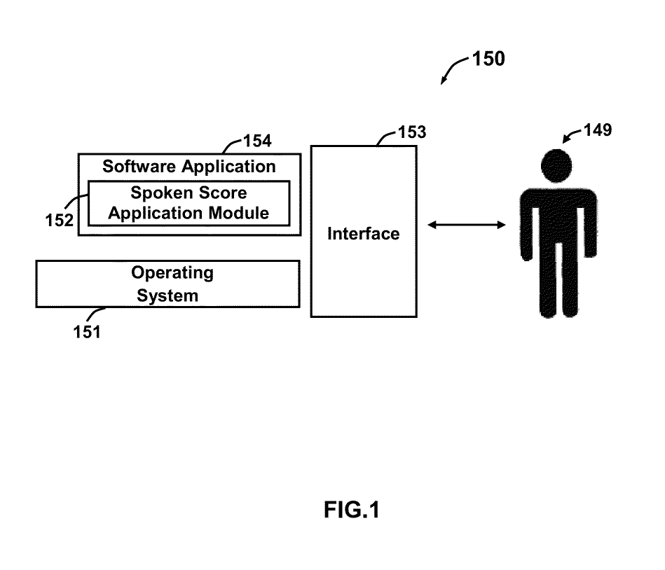

Referring now to FIG. 1, a system 150 is illustrated which includes a spoken score application module 152, an operating system 151, a software application 154, and a user interface 153 with respect to a user 149, in accordance with the disclosed embodiments. Note that the spoken score application module 152 can be stored in a memory of, for example, a data-processing apparatus, an electronic device, a mobile communication device, and other home and industrial appliances (not shown in FIG. 1). System 150 thus includes a kernel or operating system 151 and a shell or interface 153 and one or more application programs such as the spoken score application module 152.

In general, the operating system 151 can be composed of programs (e.g., modules) and data that run on computers or other data-processing devices or systems, and which manages the hardware and provides common services for efficient execution of various application software such as, for example, the spoken score application module 152. For hardware functions such as input and output and memory allocation, the operating system 151 can function as an intermediary between application programs and the computer hardware, although in most embodiments, the application code is usually executed directly by the hardware, but will frequently call the operating system 151 or be interrupted by it.

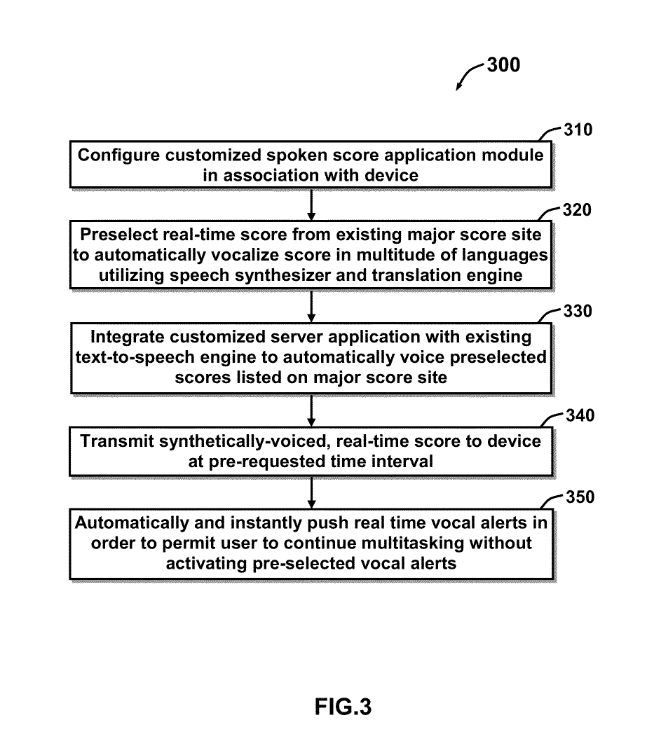

The interface 153, which is preferably a GUI (Graphical User Interface), can serve to display results, whereupon the user 149 may supply additional inputs or terminate a particular session. The spoken score application module 152 can include instructions such as those of method 300 discussed herein with respect to FIG. 3. FIG. 1 is thus intended as an example and not as an architectural limitation of the disclosed embodiments. Such embodiments, however, are not limited to any particular application or any particular computing or data-processing environment. Instead, those skilled in the art will appreciate that the disclosed system and method may be advantageously applied to a variety of system and application software.

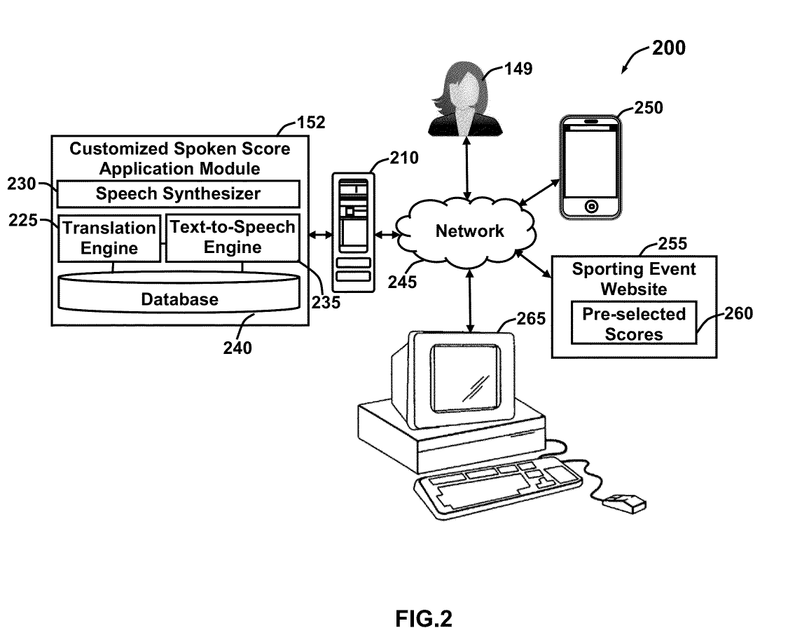

FIG. 2 illustrates a block diagram of a spoken score system 200 for vocalizing a user-selected sporting event score 260, in accordance with the disclosed embodiments. Note that in FIGS. 1-7, identical parts or elements are generally indicated by identical reference numerals. The system 200 generally includes a server 210 having the customized spoken score application module 152 configured in association with one or more devices 250 and 265 via a network 245. Note that the device can be, for example, a mobile communication device 250, a data-processing system 265, a web-enabled device, and a Bluetooth-audio-enabled vehicle, depending upon design considerations. The system 200 further includes a speech synthesizer 230 and a translation engine 225 in order to preselect the real-time score 260 by the user 149 from an existing sporting event website 255 (e.g., ESPN) to automatically vocalize the score 260 in a multitude of languages.

Speech synthesis is the artificial production of human speech. A computer system utilized for this purpose is called a speech synthesizer and can be implemented in software or hardware. The text-to-speech (TTS) engine 235 can convert normal language text into speech; other systems render symbolic linguistic representations like phonetic transcriptions into speech. Synthesized speech can be created by concatenating pieces of recorded speech that are stored in a database 240. Alternatively, a synthesizer can incorporate a model of the vocal tract and other human voice characteristics to create a completely “synthetic” voice output.

One example of a text-to-speech engine (and also speech-to-text) of the type suitable for one or more of the disclosed embodiments is disclosed in U.S. Patent Application Publication No. 2011/0111805, entitled “Synthesized Audio Message Over Communication Links,” which published on May 12, 2011 to Baptiste P. Paquier, et al. and is incorporated herein by reference in its entirety. Another example of a text-to-speech approach that can be adapted for use in accordance with one or more embodiments is disclosed in U.S. Patent Application Publication No. 2009/0313020, entitled “Text-to-Speech User Interface Control,” which published on Dec. 17, 2009 to Rami Arto Koivunen and is incorporated herein by reference in its entirety. Another example of a text-to-speech or of text-to-speech engine (and also speech-to-text) of the type (or features thereof) suitable for use with one or more of the disclosed embodiments is disclosed in U.S. Pat. No. 7,885,817 entitled “Easy Generation and Automatic Training of Spoken Dialog Systems Using Text-to-Speech,” which issued to Paek et al. on Feb. 8, 2011 and is incorporated herein by reference in its entirety.

Those skilled in the art will recognize that other text-to-speech engines and applications, including proprietary engines and approaches, are suitable for use with the embodiments. A text file containing the emergency or other alert information can be converted into an audio file such as, for example, a MP3 or similar audio file.

In general, the text-to-speech (also text-to-voice) engine 235 discussed herein can be implemented with natural speech features to voice so “robotic voice” text to speech synthesis, which is important for broadcasting or sending voice alerts in more “human” type voice audio, which is more receptive to listeners than the more “robotic voice” text-to-speech applications. Using a more natural sounding text-to-speech engine for engine 235 ensures that voice alerts are actually heard by listeners, which is particularly important during emergency situations.

It can be appreciated that the text-to-speech engine 235 can be configured to offer text-to-speech conversion in multiple languages. Such a text-to-speech engine 235 can also be configured to convert the digitized voice message into more than one language from among a plurality of languages for broadcast of the digitized voice alert in consecutively different languages through the remote electronic devices. An example of a text-to-speech application that can be adapted for use with text-to-speech engine 225 discussed herein is “Orpheus,” a multilingual text-to-speech synthesizer from Meridian One for Laptop, Notebook, and Desktop computers running Microsoft Windows Windows 7, Vista or Microsoft Windows XP. Orpheus is available as Orpheus TTS Plus or Orpheus TTS. Orpheus TTS plus and Orpheus TTS speaks 25 languages with synthetic voices capable of high intelligibility at the fastest talking rates. Orpheus TTS Plus adds natural sounding voices for UK English, US English, and Swedish. Another example of a “natural language sound” approach that can be utilized with text-to-speech engine 235 is disclosed in U.S. Patent Application Publication No. 2010/0268539 entitled “System and Method for Distributed Text-to-Speech Synthesis and Intelligibility,” which was published on Oct. 21, 2010 to Xu et al. and is incorporated herein by reference in its entirety.

An existing text-to-speech engine 235 integrated with the customized server application module 152 automatically voices the preselected scores 260 listed on the sporting event website 255. The synthetically-voiced, real-time score 260 can be transmitted to the device 250 and 265 at a predetermined time interval. The system 200 automatically and instantly pushes a vocal alert with respect to the score thereby permitting the user 149 to continue multitasking without activating the pre-selected vocal alerts.

Note that the network 245 can be an Internet connection representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network 245 may also be implemented as a number of different types of networks such as, for example, an intranet, a local area network (LAN), or a wide area network (WAN). Note that the configuration depicted in FIG. 2 is intended as an example and is not an architectural limitation with respect to different embodiments of the present invention.

The text-to-speech engine 235 provides a defined semantic schema in order to permit a grammar and application logic development to proceed simultaneously according to the semantic schema. An automated attendant is ready to speak out the latest scores 260 to enhance the nature of digital interaction. The customized server application module 152 can generate a sound file from an imported text utilizing the existing text-to-speech engine 235. The sound file can be generated by utilizing the text file (usually in ASCII format) as the source and the resulting sound file can be played back to the user 149 to listen to the scoring updates on the device 250 and 265. Such rich media content can be leveraged to build brands, attract new customers, generate revenue, and enhance mark-up language support and changes to the core algorithms.

Additionally, pronunciations and text processing are more accurate for all languages including U.S. and U.K. English, German, Canadian French, Americas Spanish, and Italian. The sound file can be generated with low latency as well as minimum resource load on the device 250 and 265. The customized server application 152 can be configured in association with the device 250 and 265, for example, an electronic device for reading text, a mobile communication device, a public information system, a warning system, a building management system, a large-format visualization system, an application that requires a dynamic speech generation, an information kiosk and panel, and other home and industrial appliances.

The synthetically-voiced, real-time score 260 can be vocalized with more accurate pronunciations and text processing for all languages, more powerful dictionary features, more capable run-time behavior configuration, enhanced mark-up language support, and changes to the core algorithms. The request can be governed by protocols and the sporting event being contested can be tapped from the device 250 and 265 to vocalize the content for the predefined time interval. The text-to-speech engine 235 and libraries work on all customer platforms and devices at maximum performance, with minimal memory and processing footprint, and highest speech quality.

FIG. 3 illustrates a high level flow chart of operations illustrating logical operational steps of a method 300 for vocalizing the user-selected sporting event score 260, in accordance with the disclosed embodiments. Note that the method 300 can be implemented in the context of a computer-useable medium that contains a program product including, for example, a module or group of modules. The customized server application module 152 can be configured in association with the mobile communication device 250, the data-processing system 265, as illustrated at block 310. The real-time score 260 can be preselected by the user 149 from an existing sporting event website 255 to automatically vocalize the score 260 in a multitude of languages utilizing the speech synthesizer 230 and the translation engine 225, as illustrated at block 320.

Next, the application module 152 can be integrated with the existing text-to-speech engine 235 which can be controlled by the application module 152 to automatically voice the preselected scores 260 listed on the sporting event website 255, as shown at block 330. The synthetically-voiced, real-time score 260 can be transmitted to the device 250 and 265 at a predetermined time interval, as indicated at block 340. Thereafter, a vocal alert with respect to the score can be pushed automatically and instantly thereby permitting the user to continue multitasking without activating the pre-selected vocal alerts, as depicted at block 350. Note that the embodiments discussed herein should not be construed in any limited sense. It can be appreciated that such embodiments reveal details of the structure of a preferred form necessary for a better understanding of the invention and may be subject to change by skilled persons within the scope of the invention without departing from the concept thereof.

When configured as a mobile application, a user can download an application from a remote website (e.g., online application store). The user can pick more than one sporting event or teams that the user wants to receive scoring information for from at least one remote live scoring website. The user can select a language in her/his profile set up that will be used for the spoken voice when the score is converted from text obtained from the website(s). It is important to note that text-to-speech conversion does not only have to occur on the remote server, but can occur on the mobile phone using the application. The user can also set up time intervals to receive score updates during application set up. For example, a user may want to receive updates every five minutes, at the end of a period/quarter/half, or only at final score.

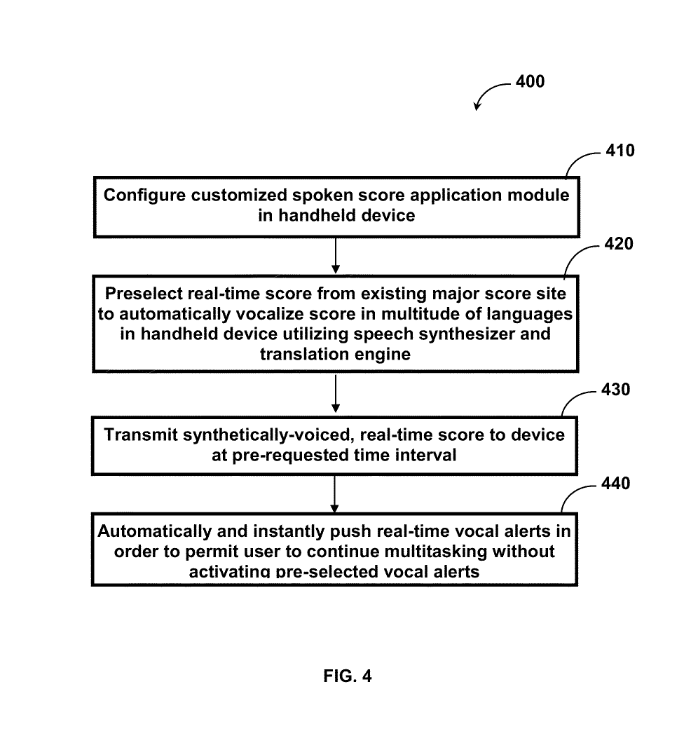

Referring to FIG. 4 another high level flow chart of operations illustrating logical operational steps of a method 400 for vocalizing the user-selected sporting event score 260 in accordance with the disclosed embodiments is illustrated. Note that the method 400 can be implemented in the context of a data-enabled mobile phone platform that contains a program product including, for example, a module or group of modules (e.g., downloaded application from an online store). Here, the customized application module can be configured in the mobile communication device, as shown in step 410. The real-time score 260 can be preselected by the user 149 to be obtained from an existing sporting event website 255 to automatically vocalize the score 260 in a multitude of languages utilizing the speech synthesizer 230 and the translation engine 225 that is based in the mobile phone, as shown in step 420. Next, the synthetically-voiced, real-time score 260 can be annunciated from the device 250 and 265 at a predetermined time interval, as indicated at block 430. Vocal alerts with respect to the scores can be announced on the mobile phone automatically and instantly without further user intervention, thereby permitting the user to continue multitasking without activating the pre-selected vocal alerts, as depicted at block 440. Note that the embodiments discussed herein should not be construed in any limited sense. It can be appreciated that such embodiments reveal details of the structure of a preferred form necessary for a better understanding of the invention and may be subject to change by skilled persons within the scope of the invention without departing from the concept thereof.

It should be further from this disclosure that personalization on a server based system enables data mining which will allow content providers to know where customers are, and what they prefer, so as to provide a better services and target marketing. Such an assessment of the user specific scores and languages should also provide some useful insights into the nature of demand and might even assist in evaluating future directions and what could be deemed a future necessity. It is also important to consider that spoken scores can be delivered to users without distracting the users during the operation of motor vehicles. The application when used with a mobile phone can take advantage of Bluetooth transmissions. Furthermore, score announcements can be preceded by a ringtone intro of a familiar theme for the score provider or as a signature alert voiced by a sportscaster of the user's choice.

It can be appreciated that a number of embodiments are disclosed, both preferred and alternative. For example, in one embodiment, a method can be implemented, which includes the steps of preselecting real-time score data from a sporting event website in order to automatically vocalize the real-time score data in at least one language utilizing a speech synthesizer and a translation engine; and announcing a synthetically-voiced real-time score based on the real-time score data preselected from the sporting event website at a device at a predetermined time interval in order to automatically and instantly push a vocal alert with respect to the real-time score data to the device. In another embodiment, the step of pre-selecting real-time score data from a sporting event website can further include preselecting the real-time score data from the sporting event website via a spoken score application. In still another embodiment, a step can be provided for integrating the spoken score application with a text-to-speech engine such that the text-to-speech engine is controllable by the spoken score application in order to automatically vocalize the preselected real-time score data as the vocal alert.

In yet another embodiment, a step can be implemented for providing defined semantic schema with respect to the text-to-speech engine in order to permit grammar and application logic development to proceed simultaneously in accordance with the defined semantic schema. In still another embodiment, a step can be provided for generating a sound file from an imported text file with respect to the score data as a source utilizing the text-to-speech engine wherein the sound file is played back to a user to listen to the score update via the device. In other embodiments, a step can be provided for generating the sound file with a low latency as well as a minimum resource load on the device.

In another embodiment, the aforementioned device can be, for example, a device such as a mobile communication device, a data-processing system, a web-enabled device, a Bluetooth audio-enabled vehicle, an electronic device, an information kiosk and panel, a plurality of home and/or industrial appliances, etc. In some embodiments, the text-to-speech engine can include a dictionary feature with enhanced mark-up language support. In yet other embodiments, steps can be provided for governing a request with respect to the score data by a protocol; and accessing the sporting event from the device to vocalize the real-time score data for a predefined time interval with a particular and accurate vocal pronunciation.

In yet another embodiment, a method can be provided, which includes the steps of vocally augmenting sports scores selected from an existing sports website via a vocalization of the sports scores; and instantly transmitting the vocalization of the sports scores at a user-requested time intervals and in a user-requested language for automatic transmission to a user device without any activation by a user of the user device. In still another embodiment, steps can be implemented for providing a uniquely configured text-to-speech engine; and applying a defined semantic schema in order to permit grammar and application logic development to proceed with digital interaction simultaneously in accordance with the defined semantic schema so as to permit an automated attendant to utter latest sports scores via the vocalization as pre-requested by a user from the existing sports website. In other embodiments, a step can be provided for automatically vocalizing the sports scores via the vocalization in multitude of languages utilizing a speech synthesizer and a translation engine.

In yet other embodiments, steps can be provided for configuring a customized server application to generate a resulting sound file indicative of the vocalization from an imported text file via a text-to-speech engine; and automatically playing back the resulting file to the user at the user-requested time intervals. In varying embodiments, the aforementioned user device can be, for example, a Smartphone, a data-processing apparatus, a web-enabled device, a Bluetooth audio-enabled vehicle, a mobile communications device, an information kiosk, a home appliance, an industrial appliance, etc.

In still another embodiment, a system can be implemented which includes, for example, a processor; a data bus coupled to the processor; and a computer-usable medium embodying computer code, the computer-usable medium being coupled to the data bus. Such computer program code can include instructions executable by the processor and configured for preselecting real-time score data from a sporting event website in order to automatically vocalize the real-time score data in at least one language utilizing a speech synthesizer and a translation engine; and transmitting a synthetically-voiced real-time score based on the real-time score data preselected from the sporting event website to a device at a predetermined time interval in order to automatically and instantly push a vocal alert with respect to the real-time score data to the device.

In other embodiments, such instructions can be further configured for pre-selecting real-time score data from a sporting event website further comprising preselecting the real-time score data from the sporting event website via a spoken score application. In still other embodiments, such instructions can be further configured for integrating the spoken score application with a text-to-speech engine such that the text-to-speech engine is controllable by the spoken score application in order to automatically vocalize the preselected real-time score data as the vocal alert. In still other embodiments, such instructions can be further configured for providing defined semantic schema with respect to the text-to-speech engine in order to permit grammar and application logic development to proceed simultaneously in accordance with the defined semantic schema. In other embodiments, such instructions can be further configured for generating a sound file from an imported text file with respect to the score data as a source utilizing the text-to-speech engine wherein the sound file is played back to a user to listen to the score update via the device.

In yet another embodiment, such instructions can be further configured for generating the sound file with a low latency as well as a minimum resource load on the device. In varying system embodiments, the device can be, for example, a mobile communication device, a data-processing system, a web-enabled device, a Bluetooth audio-enabled vehicle, an electronic device, an information kiosk and panel, a plurality of home and/or industrial appliances, etc. Such instructions can be further configured for generating the sound file with a low latency as well as a minimum resource load on the device and wherein the text-to-speech engine comprises a dictionary feature with enhanced mark-up language support. Additionally, in some embodiments, the text-to-speech engine can include a dictionary feature with enhanced mark-up language support. In other embodiments, such instructions can be further configured for governing a request with respect to the score data by a protocol; and accessing the sporting event from the device to vocalize the real-time score data for a predefined time interval with a particular and accurate vocal pronunciation.

In yet another embodiment, a system can be implemented which includes a processor, a data bus coupled to the processor, and a computer-usable medium embodying computer code, the computer-usable medium being coupled to the data bus. Such computer program code can include instructions executable by the processor and configured, for example, for vocally augmenting sports scores selected from an existing sports website via a vocalization of the sports scores, and instantly transmitting the vocalization of the sports scores at a user-requested time interval and in a user-requested language for automatic transmission to a user device without any activation by a user of the user device.

In other embodiments, such instructions can be further configured for providing uniquely configured text-to-speech engine; and applying a defined semantic schema can be applied in order to permit grammar and application logic development to proceed with digital interaction simultaneously in accordance with the defined semantic schema so as to permit an automated attendant to utter latest sports scores via the vocalization as pre-requested by a user from the existing sports website. Additionally, in some embodiments, such instructions can be further configured for automatically vocalizing the sports scores via the vocalization in multitude of languages utilizing a speech synthesizer and a translation engine. In other embodiments, such instructions can be further configured for configuring a customized server application to generate a resulting sound file indicative of the vocalization from an imported text file via a text-to-speech engine, and automatically playing back the resulting file to the user at the user-requested time intervals. In varying other embodiments, the aforementioned user device can be, for example, a Smartphone, a data-processing apparatus, a web-enabled device, a Bluetooth audio-enabled vehicle, a mobile communications device, an information kiosk, a home appliance, an industrial appliance, etc.

In another embodiment, a processor-readable medium storing code representing instructions to cause a processor to perform a process can be implemented. Such code can include code to, for example, preselect real-time score data from a sporting event website in order to automatically vocalize the real-time score data in at least one language utilizing a speech synthesizer and a translation engine; and transmit a synthetically-voiced real-time score based on the real-time score data preselected from the sporting event website to a device at a predetermined time interval in order to automatically and instantly push a vocal alert with respect to the real-time score data to the device.

In another embodiment, such code can further include code to pre-select real-time score data from a sporting event website further comprises preselecting the real-time score data from the sporting event website via a spoken score application. In other embodiments, such code can further include code to integrate the spoken score application with a text-to-speech engine such that the text-to-speech engine is controllable by the spoken score application in order to automatically vocalize the preselected real-time score data as the vocal alert. In still other embodiments, such code can include code to provide defined semantic schema with respect to the text-to-speech engine in order to permit grammar and application logic development to proceed simultaneously in accordance with the defined semantic schema.

In yet other embodiments, such code can include code to generate a sound file from an imported text file with respect to the score data as a source utilizing the text-to-speech engine wherein the sound file is played back to a user to listen to the score update via the device. In still other embodiments, such code can include code to generate the sound file with a low latency as well as a minimum resource load on the device. In some embodiments, the aforementioned text-to-speech engine can include a dictionary feature with enhanced mark-up language support. In still other embodiments, such code can include code to govern a request with respect to the score data by a protocol and access the sporting event from the device to vocalize the real-time score data for a predefined time interval with a particular and accurate vocal pronunciation.

In another embodiment, a processor-readable medium storing code representing instructions to cause a processor to perform a process can be implemented. Such code can include code to, for example: vocally augment sports scores selected from an existing sports website via a vocalization of the sports scores; and instantly transmit the vocalization of the sports scores at a user-requested time interval and in a user-requested language for automatic transmission to a user device without any activation by a user of the user device.

In other embodiments, such code can include code to provide a uniquely configured text-to-speech engine; and apply a defined semantic schema in order to permit grammar and application logic development to proceed with digital interaction simultaneously in accordance with the defined semantic schema so as to permit an automated attendant to utter latest sports scores via the vocalization as pre-requested by a user from the existing sports website.

In some embodiments, such code can further include code to automatically vocalize the sports scores via the vocalization in multitude of languages utilizing a speech synthesizer and a translation engine. In still other embodiments, such code may include code to: permit a customized server application to generate a resulting sound file indicative of the vocalization from an imported text file via a text-to-speech engine; and automatically play back the resulting file to the user at the user-requested time intervals.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method, comprising:
preselecting real-time sports data from a sporting event website in order to automatically alert a mobile device user of at least one of sports score updates and updated sports video replays; and
announcing the availability of the real-time sports data in a synthetic-voice based on at least one of information sent by or polling of a website affiliated with said real-time sports data.

2. The method of claim 1 wherein pre-selecting real-time score data from a sporting event website further comprises preselecting said real-time score data from said sporting event website via a spoken score application.

3. The method of claim 2 further comprising integrating said spoken score application with a text-to-speech engine such that said text-to-speech engine is controllable by said spoken score application in order to automatically vocalize said preselected real-time score data as said vocal alert.

4. The method of claim 3 further comprising providing defined semantic schema with respect to said text-to-speech engine in order to permit grammar and application logic development to proceed simultaneously in accordance with said defined semantic schema.

5. The method of claim 3 further comprising generating a sound file from an imported text file with respect to said score data as a source utilizing said text-to-speech engine wherein said sound file is played back to a user to listen to said score update via said device.

6. The method of claim 5 further comprising generating said sound file with a low latency as well as a minimum resource load on said device.

7. The method of claim 1 wherein said device further comprises at least one of the following types of devices:
a mobile communication device;
a data-processing system;
a web-enabled device;
a Bluetooth audio-enabled vehicle;
an electronic device;
an information kiosk and panel; and
a plurality of home and/or industrial appliances.

8. The method of claim 1 wherein said text-to-speech engine comprises a dictionary feature with enhanced mark-up language support.

9. The method of claim 1 further comprising:
governing a request with respect to said score data by a protocol; and
accessing said sporting event from said device to vocalize said real-time score data for a predefined time interval with a particular and accurate vocal pronunciation.

10. A method, comprising:
vocally augmenting sports scores selected from an existing sports website via a vocalization of said sports scores; and
instantly transmitting said vocalization of said sports scores at a user-requested time interval and in a user-requested language for automatic transmission to a user device without any activation by a user of said user device.

11. The method of claim 10 further comprising:
providing a uniquely configured text-to-speech engine; and
applying a defined semantic schema in order to permit grammar and application logic development to proceed with digital interaction simultaneously in accordance with said defined semantic schema so as to permit an automated attendant to utter latest sports scores via said vocalization as pre-requested by a user from said existing sports website.

12. The method of claim 10 further comprising automatically vocalizing said sports scores via said vocalization in multitude of languages utilizing a speech synthesizer and a translation engine.

13. The method of claim 10 further comprising:
configuring a customized server application to generate a resulting sound file indicative of said vocalization from an imported text file via a text-to-speech engine; and
automatically playing back said resulting file to said user at said user-requested time intervals.

14. A system, comprising:
a processor;
a data bus coupled to said processor; and
a computer-usable medium embodying computer code, said computer-usable medium being coupled to said data bus, said computer program code comprising instructions executable by said processor and configured for:
preselecting real-time score data from a sporting event website in order to automatically vocalize said real-time score data in at least one language utilizing a speech synthesizer and a translation engine; and
transmitting a synthetically-voiced real-time score based on said real-time score data preselected from said sporting event website to a device at a predetermined time interval in order to automatically and instantly push a vocal alert with respect to said real-time score data to said device.

15. The system of claim 14 wherein said instructions are further configured for pre-selecting real-time score data from a sporting event website further comprising preselecting said real-time score data from said sporting event website via a spoken score application.

16. The system of claim 15 wherein said instructions are further configured for integrating said spoken score application with a text-to-speech engine such that said text-to-speech engine is controllable by said spoken score application in order to automatically vocalize said preselected real-time score data as said vocal alert.

17. The system of claim 16 wherein said instructions are further configured for providing defined semantic schema with respect to said text-to-speech engine in order to permit grammar and application logic development to proceed simultaneously in accordance with said defined semantic schema.

18. The system of claim 16 wherein said instructions are further configured for generating a sound file from an imported text file with respect to said score data as a source utilizing said text-to-speech engine wherein said sound file is played back to a user to listen to said score update via said device.

19. The system of claim 18 wherein said instruction are further configured for generating said sound file with a low latency as well as a minimum resource load on said device.

20. The system of claim 18 wherein said instruction are further configured for generating said sound file with a low latency as well as a minimum resource load on said device and wherein said text-to-speech engine comprises a dictionary feature with enhanced mark-up language support.
